(19) United States
(12) Patent Application Publication
(10) Pub. No.: US 2019/0332799 A1
(43) Pub. Date: Oct. 31, 2019

(54) PRIVACY PROTECTION DEVICE

(71) Applicant: Hewlett-Packard Development Company, L.P., Spring, TX (US)

(72) Inventors: Mary G. Baker, Palo Alto, CA (US); Helen A. Holder, Palo Alto, CA (US); Ian N. Robinson, Palo Alto, CA (US); David Murphy, Palo Alto, CA (US)

(73) Assignee: Hewlett-Packard Development Company, L.P., Spring, TX (US)

(21) Appl. No.: 16/345,395

(22) PCT Filed: Jan. 19, 2017
(86) PCT No.: PCT/US2017/014121

§ 371 Date: Apr. 26, 2019

(51) Int. Cl. G06F 21/62; G06F 21/83; G06F 21/60

(52) U.S. Cl. CPC G06F 21/6245; G06F 21/604; G06F 21/629; G06F 21/83

(57) ABSTRACT

A privacy protection device may include a disabling module to prevent at least one sensor on an always-on device from sensing input and an activation sensor to detect when the at least one sensor is to be activated on the always-on device, wherein the disabling module is integrated into the always-on device

### BACKGROUND

Many devices today including smart home assistants, smart personal assistants, and wearable devices incorporate sensors such as cameras, microphones, and motion sensors. These sensors allow these types of devices to gather data in order to perform facial and speaker recognition, respond to commands, perform activity recognition and otherwise operate as directed by a user.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1 is a diagram of a privacy protection device according to one example of the principles described herein.

FIG. 2 is a flowchart showing a method of maintaining privacy with an always-on device according to one example of the principles described herein.

FIG. 3 is a block diagram of a human interface device according to an example of the principles described herein.

FIGS. 4A and 4B are front views of a privacy protection device of FIG. 1 according to one example of the principles described herein.

Throughout the drawings, identical reference numbers designate similar, but not necessarily identical, elements.

### DETAILED DESCRIPTION

As described above, a number of devices today operate by continuously detecting input from users of the devices. Through the use of sensors such as cameras, microphones, and motion sensors, these devices gather data in order to perform facial and speaker recognition, respond to commands, perform activity recognition and otherwise operate as directed by a user. In order to perform their intended operations, these devices are “always-on” or ready to either be activated by an audio or image input or are constantly buffering an image or audio in preparation for future input from a user. Consequently, while functioning, these devices provide a path for users to be constantly observed or listened to sometimes without their knowledge. Such constant monitoring may cause concern among customers who do not understand when they are being seen, heard, or otherwise observed by devices.

Some devices are sold with the assertion that although they are constantly receiving input, any video or audio produced of the user is not being maintained or sent to another destination. These types of devices may implement a “waking word” or “waking action” that a user performs in order to activate the device in preparation for the input from the user to be acted on. Still, these devices may be susceptible to alteration especially where the device is connected to a network such as the Internet.

Some devices incorporate an indicator that allows a user to determine when the device is receiving input and acting upon the input. Some of these indicators, such as LED devices, indicate the status of the sensor and show whether a camera, for example, is enabled. These indicators, however, may or may not be trusted by users because the indicators can often be controlled separately from the sensors themselves. Further, these indicators can also be irritating to the user adding light and sound to environments where it is not always wanted.

Domestic spaces as well as office spaces suffer from the use of these devices because they are often equipped with cameras and microphones for safety purposes or as part of remote collaboration systems. Employees, for example, who work with confidential documents or objects would benefit more from knowing when and where the materials they are working with are under observation.

The present specification, therefore describes a privacy protection device that includes a disabling module to prevent at least one sensor on an always-on device from sensing input and an activation sensor to detect when the at least one sensor is to be activated on the always-on device wherein the disabling module is integrated into the always-on device.

The present specification further describes a method of maintaining privacy with an always-on device including, with a disabling module, preventing the activation of at least one sensor on the always-on device and, with an activation sensor, detecting an activation action from a user. In an example, the activation sensor is relatively less privacy invasive than the at least one sensor on the always-on device.

The present specification further describes a human interface device including an always-on device, including at least one sensor, and an activation sensor to receive input from a user before the at least one sensor of the always-on device may be activated wherein after activation of the at least one sensor of the always-on device, the always-on device senses a wake-up action from a user.

As used in the present specification and in the appended claims, the term “always-on device” or “always-on sensor” is meant to be understood as any sensor or device that is activated by an audio, seismic, temperature, associated electromagnetic field emitting from a device associated with a user, or image input from a user and that is constantly buffering the audio, seismic, or image input in preparation for detection of a wake input from a user.

Further, as used in the present specification and in the appended claims, the term “a number of” or similar language is meant to be understood broadly as any positive number comprising 1 to infinity.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with that example is included as described, but may not be included in other examples.

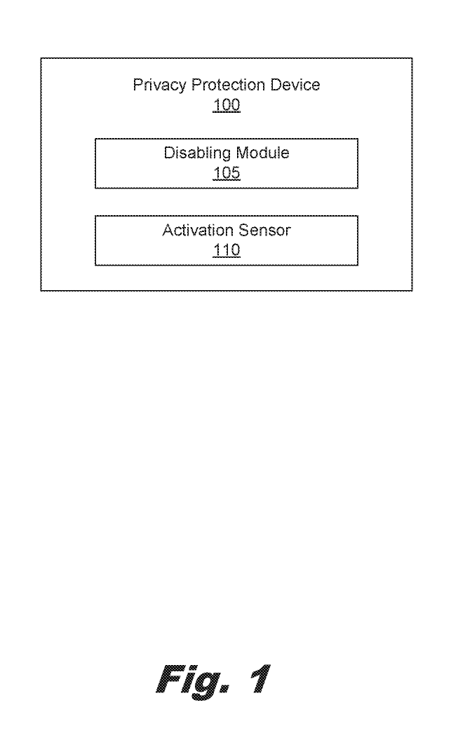

Turning now to the figures, FIG. 1 is a diagram of a privacy protection device (100) according to one example of the principles described herein. The privacy protection device (100) may be implemented in an electronic device. Examples of electronic devices include servers, desktop computers, laptop computers, personal digital assistants (PDAs), mobile devices, smartphones, gaming systems, tablets, smart home assistants, smart personal assistants, smart televisions, smart mirrors, smart toys, and wearables among other electronic devices and smart devices.

The privacy protection device (100) may be utilized in any data processing scenario including, stand-alone hardware, mobile applications, through a computing network, or combinations thereof. Further, the privacy protection device (100) may be used in a computing network, a public cloud network, a private cloud network, a hybrid cloud network, other forms of networks, or combinations thereof.

The privacy protection device (100) may include a disabling module (105) integrated into an always-on device and an activation sensor (110). These will be described in more detail below. To achieve its desired functionality, the privacy protection device (100) may further include various hardware components. Among these hardware components may be a number of processors, a number of data storage devices, a number of peripheral device adapters, and a number of network adapters. These hardware components may be interconnected through the use of a number of busses and/or network connections. In one example, the processor, data storage device, peripheral device adapters, and network adapter may be communicatively coupled via a bus. In an example, the disabling module (105) and activation sensor (110) of the privacy protection device (100) may be communicatively coupled to the other hardware of the privacy protection device (100) such that the disabling module (105) and activation sensor (110) may not be removed from the privacy protection device (100) without a user being capable of visually detecting the removal. In this example, the operation of the disabling module (105) and activation sensor (110) may supersede the operation of the sensors of the privacy protection device (100). This, thereby, allows control by the disabling module (105) and activation sensor (110) over the sensors of the always-on device. In an example, a user may remove the disabling module (105) and/or activation sensor (110) thereby indicating visually that the always-on device does not include the privacy protection device (100) coupled thereto and is currently receiving input from the user. As described below, the removal of the disabling module (105) and/or activation sensor (110) may act as the visual cue to a user that his or her actions, sounds, or images may be intermittently or constantly monitored without his or her knowledge.

The processor of the privacy protection device (100) may include the hardware architecture to retrieve executable code from the data storage device and execute the executable code. The executable code may, when executed by the processor, cause the processor to implement at least the functionality of deactivating a sensor of the always-on device and detecting an activation action from a user with an activation sensor according to the methods of the present specification described herein. In the course of executing code, the processor may receive input from and provide output to a number of the remaining hardware units.

The data storage device of the privacy protection device (100) may store data such as executable program code that is executed by the processor or other processing device. As will be discussed, the data storage device may specifically store computer code representing a number of applications that the processor executes to implement at least the functionality described herein.

The data storage device may include various types of memory modules, including volatile and nonvolatile memory. For example, the data storage device of the present example includes Random Access Memory (RAM), Read Only Memory (ROM), and Hard Disk Drive (HDD) memory. Many other types of memory may also be utilized, and the present specification contemplates the use of many varying type(s) of memory in the data storage device as may suit a particular application of the principles described herein. In certain examples, different types of memory in the data storage device may be used for different data storage needs. Generally, the data storage device may comprise a computer readable medium, a computer readable storage medium, or a non-transitory computer readable medium, among others. For example, the data storage device may be, but not limited to, an electronic, magnetic, optical, electromagnetic, infrared, or semiconductor system, apparatus, or device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The hardware adapters in the privacy protection device (100) enable the processor to interface with various other hardware elements, external and internal to the privacy protection device (100). For example, the peripheral device adapters may provide an interface to input/output devices, such as, for example, display device, a mouse, or a keyboard. The peripheral device adapters may also provide access to other external devices such as an external storage device, a number of network devices such as, for example, servers, switches, and routers, client devices, other types of computing devices, and combinations thereof.

The display device may be provided to allow a user of the privacy protection device (100) to interact with and implement the functionality of the privacy protection device (100) by, for example, allowing a user to determine if and how a number of sensors of the privacy protection device (100) are to be disabled by the disabling module (105) or activated by the activation sensor (110). The peripheral device adapters may also create an interface between the processor and the display device, a printer, or other media output devices. The network adapter may provide an interface to other computing devices within, for example, a network, thereby enabling the transmission of data between the privacy protection device (100) and other devices located within the network.

The disabling module (105) may be any type of module that prevents a sensor in the privacy protection device (100) from being an “always-on” device. In an example, the disabling module (105) may be a physical barrier placed over a sensor of the privacy protection device (100) such that the sensor may not receive audio, seismic, video or other type of input to the sensor of the privacy protection device (100). In an example, the disabling module (105) may be an electrical circuit within the privacy protection device (100) that prevents at least one sensor within the always-on device from sensing until an indication from the activation sensor (110) has been received. When the indication from the activation sensor (110) is received by the disabling module (105), the disabling module (105) may re-enable the at least one sensor of the always-on device thereby allowing the always-on device to be operated by, for example, the use of a wake word or other activation action by the user.

The activation sensor (110) may be any sensor that can detect an activation action by a user. In an example, the activation sensor (110) may be set in a state of always detecting the activation action by the user. Although the input by the user to the activation sensor (110) may vary, in an example, the output of the activation sensor (110) may be binary or enumerative. The binary or enumerative output of the activation sensor (110) prevents any recording and storage of an image, activity, or audio of a user that does not intend to be maintained.

In an example, the activation sensor (110) is a camera that detects the presence of a user. In an example, the detection of the presence of the user may be the detection of a specific user using, for example, facial recognition. In this example, the output signal from the activation sensor (110) is enumerative in that they identify the specific person and enumerate that that specific person is visible. In an example, the detection of the presence of the user may be the detection of a user generally without the use of facial recognition. In this example, the output signal from the activation sensor (110) is binary in that the signal either indicates that there is no person visible or that there is a person visible.

In an example, as the camera detects the presence of a user, the processor associated with the privacy protection device (100) may receive the binary or enumerative output from the camera that either a user is or is not detected within an image. Because the binary or enumerative output is limited to a signal and does not record the image, activity, or audio of a user, the invasive nature of the activation sensor (110) is limited. This provides for a privacy protection device (100) that is relatively less invasive than a sensor that is continuously on and monitoring the user and outputting privacy-sensitive information. The use of the binary or enumerative output from the camera also deters a potential third party that has breached the network defenses associated with the privacy protection device (100). This is because the third party has breach the network defenses in order to obtain access to the sensors of the privacy protection device (100) and monitor the audio, activity, and/or video of the user nefariously. Because the output of the activation sensor (110) is binary, limited information is made available to the third party.

In an example, the activation sensor (110) is a seismic detector capable of detecting seismic activity around the privacy protection device (100). In an example, the seismic activity is a specific cadence of a walk of a user. In an example, the seismic activity is any seismic activity detected by the privacy protection device (100). In an example, the seismic activity detected may be the footsteps of a specific person based on the cadence or gait of the user's steps. In this example, the output of the activation sensor (110) is enumerative of who the person is. In an example, the seismic activity may be a specific tapping sequence of a user. In this example, the specific tapping sequence of a user may be predefined by the user prior to use of the privacy protection device (100). Here the user may add a level of security to the privacy protection device (100) in order to activate it through the seismic sensor. This allows a user to activate the privacy protection device (100) and activate the sensors of the privacy protection device (100) when the specific seismic tap is detected. Again, as the seismic sensor detects the seismic activity in any of the examples above, the processor associated with the privacy protection device (100) may receive a binary output from the seismic sensor indicating that either seismic activity is or is not detected. Because the binary output is limited to a signal and does not record the image, activity, or audio of a user, the invasive nature of the activation sensor (110) is limited. This provides for a privacy protection device (100) that is less invasive than a sensor that is continuously on and monitoring the user. The use of the binary output from the seismic sensor also thwarts a potential third party that has breached the network defenses associated with the privacy protection device (100) in order to obtain access to the sensors of the privacy protection device (100) in order to obtain audio, activity, and/or video of the user nefariously.

In an example, the activation sensor (110) is a microphone. The microphone may detect the voice of a user. In an example, the voice detected by a user may be the voice from a specific user. The voice from the specific person may be detected by a voice recognition application executed by the processor associated with the privacy protection device (100). In an example, the voice of any user may be detected. However, as the microphone detects the voice of a user in any of the examples above, the processor associated with the privacy protection device (100) may receive a binary output from the microphone indicating that a user's voice is or is not detected. Because the binary output is limited to a signal and does not record the image, activity, or audio of a user, the invasive nature of the activation sensor (110) is limited. This provides for a privacy protection device (100) that is less invasive than a sensor that is continuously on and monitoring the user. The use of the binary output from microphone also prevents a potential third party that has breached the network defenses associated with the privacy protection device (100) in order to obtain access to the sensors of the privacy protection device (100) in order to obtain audio, activity, and/or video of the user nefariously.

In an example, the activation sensor (110) is an electric field proximity sensor that detects an electrical field produced by a user. In this example, the electric field proximity sensor may detect an electric field as it passes through the privacy protection device (100). This field may be produced by a user's hand, for example, indicating that the user intends for the activation sensor (110) to send the binary signal as described above. Again, a binary output from the electric field proximity sensor may be provided to indicate that a user intends for the sensors in the privacy protection device (100) to be activated.

In an example, the activation sensor (110) is a motion sensor. The motion sensor may generally detect motion via, for example a camera. In this example, a less distinct image of an object moving within the detectable area of the motion sensor may activate the sensors of the privacy protection device (100) and send the binary output as described above. The motion sensor may further limit the amount of data being detected thereby reducing the amount of visual data provided to the privacy protection device (100). In addition to the binary output of the motion sensor, the use of the motion sensor may provide additional assurances to a user that data regarding the user is not saved or streamed over a network as the always-on sensors of the privacy protection device (100) would.

In an example, the activation sensor (110) is a wearable device detection sensor. The wearable device detection sensor may detect the presence of a wearable or moveable device such as a fitness monitor, a NFC device, a Wi-Fi device, a security tag, and a computing device, among others. Again, as the wearable device detection sensor senses the presence of such a device, it may indicate the presence using the binary output as described above.

In each of the above examples of the activation sensor (110) described above, the user is prevented from being monitored by actively engaging the privacy protection device (100) and the activation sensor (110). This allows a user to actively turn on the “always-on” sensors of the privacy protection device (100) in order to avoid having the “always-on” devices monitoring the user's activity without the user's knowledge of such monitoring. In the example where the camera is used, a user may actively activate the always-on sensors of the privacy protection device (100) by performing a recognizable gesture, and/or showing his or her face at the camera for face recognition. Thus, the user may be active by intentionally addressing the camera as descried thereby preventing the always-on sensors of the privacy protection device (100) from activating unless the user engages in these activities. In the case where the activation sensor (110) is a seismic sensor, a user may actively tap a surface or stomp a foot on the ground using a predetermined pattern as described above. In this example, a user has actively engaged with the seismic sensor and therefor will active the always-on sensors of the privacy protection device (100). In the case where the activation sensor (110) is a motion sensor, a user may actively engage with the motion sensor by again initiating a specific gesture within a viewable area of the motion sensor. In this example, a specific pattern of motion of the user within the viewable area may act as the active engagement with the motion sensor that activates the “always-on” sensors in the privacy protection device (100).

In addition to the activation sensor (110) and the disabling module (105) described above, the privacy protection device (100) may further include a visual cue that indicates that the privacy protection device (100) and the always-on sensors are activated or have been activated by the activation sensor (110). In some “always-on” devices, a light-emitting diode (LED) or other device integrated indicator is used to indicate when the “always-on” sensors of the devices are activated. However, this LED is not always independent of the activation of the sensors in the “always-on” devices. As such, should the “always-on” device be compromised through, for example, an internet connection, the LED may be caused to remain off while the sensors of the “always-on” devices are functioning unbeknownst to the user. As a result, in “always-on” devices a user may be monitored via audio and/or video inputs without his or her knowledge. The privacy protection device (100), however, includes a visual cue that indicates the “always-on” device is on. In an example, the visual cue is tied to the functioning of the sensors of the privacy protection device (100) such that the sensors of the privacy protection device (100) are not activated without activation of the visual cue. This may be done by coupling any electrical circuit associated with the circuit of the sensors of the privacy protection device (100) such that activation of the sensors is dependent on the activation of the visual cue. Some examples include an LED that is tied into the circuitry of the privacy protection device (100) as described above as well as the physical barriers and their associated electro-mechanical hardware that cause the barriers to be moved away from the sensors of the privacy protection device (100) before activation of the sensors. A number of examples will be described in more detail below.

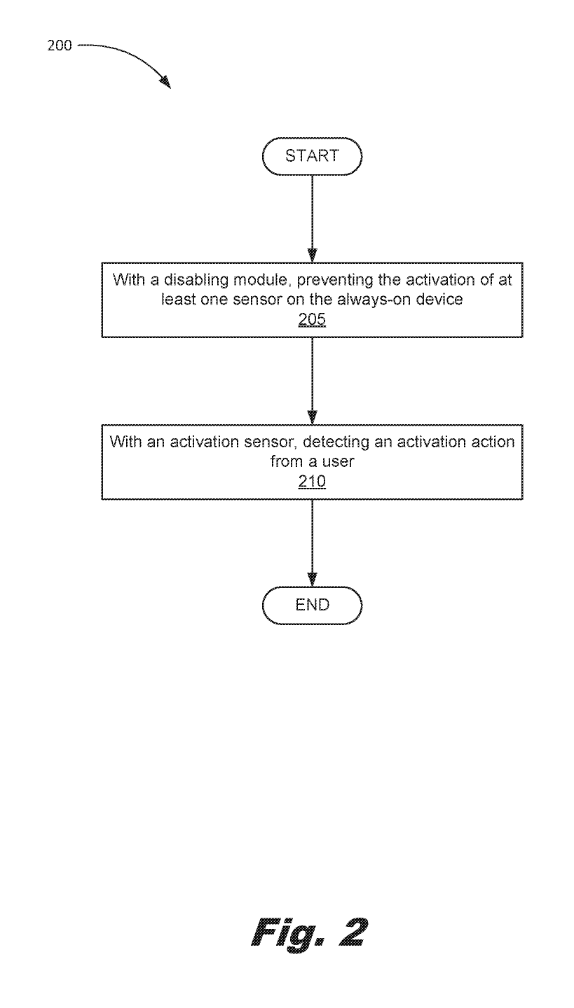

FIG. 2 is a flowchart showing a method (200) of maintaining privacy with an always-on device according to one example of the principles described herein. The method (200) may begin with preventing (205) the activation of at least one sensor on the always-on device with a disabling module. As described above, the disabling module (105) may be any type of module that prevents a sensor in the privacy protection device (100) from being an “always-on” device. During operation of the always-on device prevents the activation of at least one sensor of the always-on device until a user has actively engaged the always-on device as described herein.

The method (200) therefore continues by detecting (210) an activation action from a user with an activation sensor. As described above, the activation action may be any intentional or active action by a user of the “always-on” device and that is detected by the activation sensor. The activation sensor may be any form of sensor apart from the sensors of the “always-on” devices and that can determine if a user actively intends to activate the sensors of the “always-on” device. Specific, examples of an activation sensor (110) have been described herein.

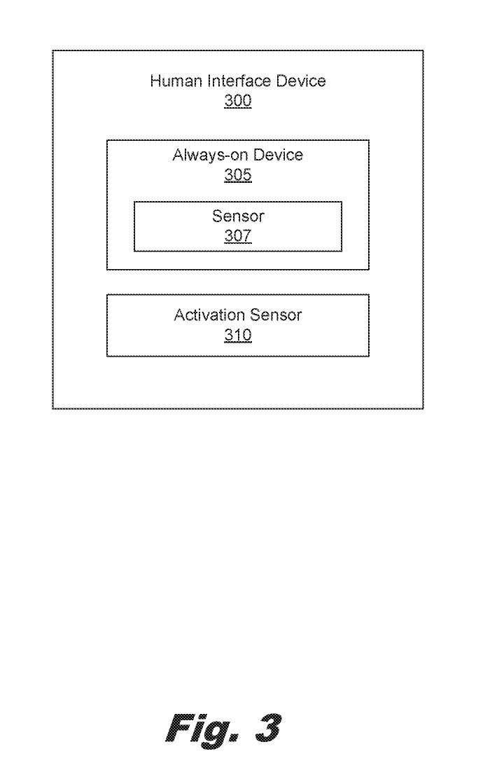

FIG. 3 is a block diagram of a human interface device (300) according to an example of the principles described herein. The human interface device (300) may include an always-on device (305), including at least one sensor (307), and an activation sensor (310). As described above, the always-on device (305) of the human interface device (300) may include any sensor (307) that is configured to always monitor the actions, noises, and/or image of a user while around the human interface device (300). This may make certain users uncomfortable with the constant monitoring via these sensors (307). As such the human interface device (300) also includes an activation sensor (310) that detects active actions from a user and activates the always-on device (305) of the human interface device (300). The activation sensor may detect, for example, seismic activity, a face of a user, a specific noise, a Wi-Fi signal, a NFC signal, and a motion of a user, among others. Thus, the sensor (307) of the always-on device (305) is disabled until the activation sensor (310) provides a signal indicating that the sensor (307) of the always-on device (305) may be activated and operate by continuously monitoring the actions, noises, and/or image of a user.

While the activation sensor (310) is continuously detecting these actions from a user, a binary output is provided to the human interface device (300). The binary output includes a negative or positive output indicating either that the always-on sensor (305) of the human interface device (300) should not be activated or should be activated, respectively.

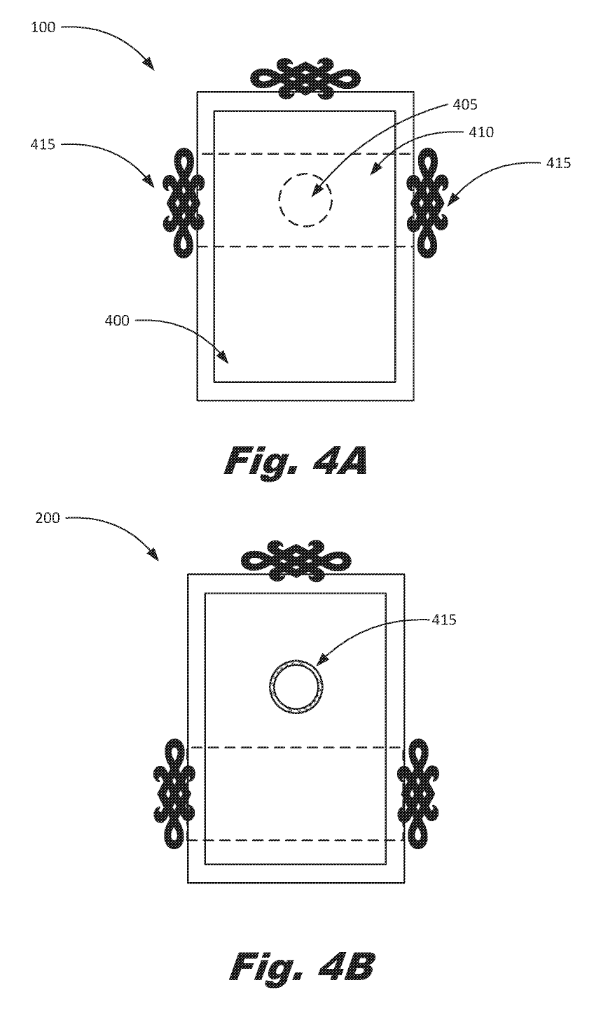

FIGS. 4A and 4B are front views of a privacy protection device (100) of FIG. 1 according to one example of the principles described herein. In this example, the privacy protection device (100) includes a disabling module (105) and activation sensor (110) as described in connection with FIG. 1. The privacy protection device (100) is in the form of a one-way mirror (400) having a video recording device (405) placed behind it and directed out from the back of the one-way mirror (400). The privacy protection device (100) further includes a shroud (410) placed between the one-way mirror (400) and the video recording device (405) thereby acting as the disabling module (105) to disable, at least, the video recording device (405). The video recording device (405) is disabled by the shroud (410) by preventing the video recording device (405) from recording an image beyond the one-way mirror (400). As described above, the shroud (410) via the disabling module (105) may not only physically prevent an image from being captured by the video recording device (405) but may also include electronic circuitry that places the shroud (410) in front of the video recording device (405) until the activation sensor (110) senses an active action by the user to remove the shroud (410) from in front of the “always-on” video recording device (405). In an example, activation of the video recording device (405) will not occur until the binary signal from the activation sensor (110) is received by the privacy protection device (100) and the shroud (410) is removed from in front of the video recording device (405). At that instance, the video recording device (405) is activated and remains on until disabled by the disabling module (105) upon an action by the user.

The one-way mirror (400) of the privacy protection device (100) further includes a number of visual cues (415). The visual cues (415) in this example are a number of embellishments coupled physically to the shroud (410). These visual cues (415) being mechanically coupled to the shroud (410) indicate to a user that the video recording device (405) is activated because the visual cues (415) are moved towards the bottom of the one-way mirror (400). A user may understand from this that, at least, and image of them may be captured by the video recording device (405) when the visual cues (415) are in this position. This allows a user to immediately understand the status of the privacy protection device (100) as the user walks into an area where this privacy protection device (100) is located. As described above, the disabling module (105) and shroud (410) may be electrically coupled to the privacy protection device (100) such that any activation of the video recording device (405) is done via the active actions by a user as describe herein.

The video recording device (405) of FIGS. 4A and 4B may further include a separate visual cue (415) in the form of an embellishment located on a portion of the video recording device (405) around a lens of the video recording device (405). In the example shown in FIG. 4B, the embellishment may include a visually perceptible color surrounding the lens of the video recording device (405) such that movement of the shroud (410) allows a user to view the accentuated color of the visual cues (415) through the one-way mirror (400).

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, the processor of the privacy protection device (100) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a privacy protection device and method of maintaining privacy with an always-on device. The system implements a disabling module and an activation sensor that disables an “always-on” sensor in the privacy protection device and activates those sensors, respectively, when a user actively engages the privacy protection device. This provides a higher level of privacy to those users who do not want “always-on” devices to constantly be monitoring their actions while in proximity to the “always-on” devices. Additionally, because the output from the activation sensor is binary, any actual data such as audio or video records cannot be maintained by the privacy protection device.

The preceding description has been presented to illustrate and describe examples of the principles described. This description is not intended to be exhaustive or to limit these principles to any precise form disclosed. Many modifications and variations are possible in light of the above teaching.

What is claimed is:

1. A privacy protection device, comprising:
a disabling module to prevent at least one sensor on an always-on device from sensing input, wherein the disabling module is integrated into the always-on device; and
an activation sensor to detect when the at least one sensor is to be activated on the always-on device.

2. The privacy protection device of claim 1, wherein the activation sensor is a seismic sensor.

3. The privacy protection device of claim 2, wherein the seismic sensor detects the cadence of a user walking, a pattern of seismic activity, or a combination thereof.

4. The privacy protection device of claim 1, wherein the activation sensor is a microphone and wherein the microphone detects a voice of a user and provide, as output, a binary signal indicating that a user is or is not present.

5. The privacy protection device of claim 1, wherein the activation sensor provides a binary output of positive or negative wherein a positive output results in activation of the always-on device.

6. The privacy protection device of claim 5, wherein the activation sensor is a camera that provides the binary output of a user present or not present within the image.

7. The privacy protection device of claim 6, wherein the detection of whether the user is or is not present within the image comprises determining whether a specifically identified user is present or not present within the image.

8. The privacy protection device of claim 1, wherein activation of the always-on device via the activation sensor further comprises activating a visual cue that indicates that the always-on device is activated.

9. The privacy protection device of claim 1, wherein removal of the disabling module from the always-on device visually indicates to a user that the always-on device is activated.

10. A method of maintaining privacy with an always-on device, comprising:
with a disabling module, preventing the activation of at least one sensor on the always-on device; and
with an activation sensor, detecting an activation action from a user.

11. The method of claim 10, wherein the activation action is a seismic pattern.

12. The method of claim 10, wherein the activation is a binary indication that a user is viewable or not viewable within an image.

13. A human interface device comprising:
an always-on device comprising at least one sensor; and
an activation sensor to receive input from a user before the at least one sensor of the always-on device may be activated;
wherein after activation of the at least one sensor of the always-on device, the always-on device senses a wake-up action from a user.

14. The human interface device of claim 13, wherein the activation sensor is a camera that provides to the human interface device with a binary output describing whether a user is or is not within view of the camera.

15. The human interface device of claim 13, wherein the activation sensor is a seismic sensor to detect seismic activity within a vicinity of the device.
